(19) United States
(12) Patent Application Publication
(10) Pub. No.: US 2026/0292181 A1
(43) Pub. Date: Sep. 24, 2026

(54) CONCEPT FOR FURTHER TRAINING OF A PRE-TRAINED VERSION OF A DECODER FITTING TO A VARIATIONAL PICTURE AUTOENCODER

(71) Applicant: Fraunhofer-Gesellschaft zur Förderung der angewandten Forschung e.V., München (DE)

(72) Inventors: Florian BORZECHOWSKI, Berlin (DE); Michael SCHÄFER, Berlin (DE); Jonathan PFAFF, Berlin (DE); Heiko SCHWARZ, Berlin (DE); Detlev MARPE, Berlin (DE); Thomas WIEGAND, Berlin (DE)

(21) Appl. No.: 19/692,587

(22) Filed: May 29, 2026

Related U.S. Application Data
(63) Continuation of application No. PCT/EP2024/084026, filed on Nov. 29, 2024.

(30) Foreign Application Priority Data
Dec. 1, 2023 (DE) 23213788.5

(51) Int. Cl. H04N 19/13; G06N 20/00; H04N 19/124; H04N 19/147; H04N 19/172; H04N 19/42

(52) U.S. Cl. CPC H04N 19/13; G06N 20/00; H04N 19/124; H04N 19/147; H04N 19/172; H04N 19/42

(57) ABSTRACT

The application describes an apparatus for further training a pre-trained version of a decoder fitting to a variational picture autoencoder, the decoder having a hyperdecoder for deriving statistical entropy-coding parameters from a quantized hyperprior in a data stream, an entropy decoder for decoding quantized latents from the data stream using the statistical entropy-coding parameters, and a latents-to-picture decoder for deriving from the quantized latents a decoded picture, the apparatus configured to provide a training set of training data elements corresponding to a set of various test pictures, each training data element having quantized latents resulting from applying the variational picture autoencoder to an associated test picture, and train the latents-to-picture decoder on the training set with respect to distortion optimization to obtain a further trained version of the latents-to-picture decoder. Further, another variant trains the hypercoder system. The resulting decoder and autoencoder/decoder pair is also described.

### CROSS-REFERENCE TO RELATED APPLICATIONS

This application is a continuation of copending International Application No. PCT/EP2024/084026, filed Nov. 29, 2024, which is incorporated herein by reference in its entirety, and additionally claims priority from European Application No. 23213788.5, filed Dec. 1, 2023, which is also incorporated herein by reference in its entirety.

### TECHNICAL FIELD

Embodiments of the present disclosure relate to a decoder, decoding an image represented by latent variables and hyperpriors.

### BACKGROUND OF THE INVENTION

Compressing images using neural networks has developed into a promising coding technique [1], [2], offering alternatives to modern coding standards like VVC [3] or HEVC [4], while achieving similar or even better compression performance. Variational Autoencoders (VAEs) [5] first nonlinearily transform the input image into latents, which are then may be quantized and entropy coded with conventional methods like arithmetic coding [6]. The decoder may perform another nonlinear transform to reconstruct an approximation of the input image. The entropy coding process usually utilizes another nonlinear network to estimate the probability distributions of the quantized latents, which then may be used in the arithmetic coder. A possible approach for this estimation is applying a hypercoder network [7], [8], which may further compress the latents into side information which can be transmitted together with the quantized latents. The distributions of the latent variables may be approximated as normal distributions and the transmitted side information may be used by both encoder and decoder to calculate estimated mean and variance values. The arithmetic coder may use the probabilities that are obtained by quantizing the estimated normal distributions, which may vastly improve overall rate-distortion performance. This basic approach can, for example, be further improved by incorporating autoregressive probability estimation, or by using transmitted side information to estimate the parameters of more complex distribution models [9], [10]. The models are trained using an end-to-end-approach, allowing the different parts of the neural network to be optimized jointly with respect to minimizing the rate-distortion cost [11]. However, taking quantization into account during the end-to-end training process is nontrivial. Quantization functions such as uniform scalar quantization (USQ) or trellis coded quantization (TCQ) [12], [13] have zero gradients almost everywhere, impeding the backpropagation of the learning process with respect to the weights of the encoding network and therefore disallowing end-to-end training. Hence, quantization is usually replaced with an approximation of its impact on the latents. Previous approaches utilize noise perturbation [7], [8], [14], straight-through estimation [15], [16], and similar other approximations [17]-[19]. The findings of [19] in particular indicate that there is no single optimal approximation, but that different approximations work better for different network architectures.

Thus, it is desirable to provide a concept leading to more efficient picture autoencoding codec such as by improving existing methods of training neural network based coding approaches.

### SUMMARY

An embodiment may have an apparatus for further training a pre-trained version of a decoder fitting to a variational picture autoencoder, the decoder having a hyperdecoder for deriving statistical entropy-coding parameters from a quantized hyperprior in a data stream, an entropy decoder for decoding quantized latents from the data stream using the statistical entropy-coding parameters, and a latents-to-picture decoder for deriving from the quantized latents a decoded picture, the apparatus configured to provide a training set of training data elements corresponding to a set of various test pictures, each training data element having quantized latents resulting from applying the variational picture autoencoder to an associated test picture, and train the latents-to-picture decoder on the training set with respect to distortion optimization to obtain a further trained version of the latents-to-picture decoder.

An embodiment may have an apparatus for further training a pre-trained version of a decoder fitting to a variational picture autoencoder, the decoder having a hyperdecoder for deriving statistical entropy-coding parameters from a quantized hyperprior in a data stream, an entropy decoder for decoding quantized latents from the data stream using the statistical entropy-coding parameters, and a latents-to-picture decoder for deriving from the quantized latents a decoded picture, the apparatus configured to provide a further training set of further training data elements corresponding to a further set of various test pictures, each further training data element having unquantized latents and quantized latents resulting from applying the variational picture autoencoder to an associated test picture, and train a hypercoder system having the hyperdecoder and a hyperencoder of the variational picture autoencoder on the further training set with respect to rate-distortion optimization to obtain a further trained version of the hyperdecoder and a further trained version of the hyperencoder.

According to another embodiment, a decoder fitting to a variational picture autoencoder may have: a hyperdecoder for deriving statistical entropy-coding parameters from a quantized hyperprior in a data stream, an entropy decoder for decoding quantized latents from the data stream using the statistical entropy-coding parameters, and a latents-to-picture decoder for deriving from the quantized latents a decoded picture, wherein a parametrization of the latents-to-picture decoder lies in a minimum of a distortion function from a quantized latent domain to distortion with respect to parameters of the latents-to-picture decoder

Another embodiment may have a system of a variational picture autoencoder and a decoder fitting to the variational picture autoencoder, wherein the decoder has a hyperdecoder for deriving statistical entropy-coding parameters from a quantized hyperprior in a data stream, an entropy decoder for decoding quantized latents from the data stream using the statistical entropy-coding parameters, and a latents-to-picture decoder for deriving from the quantized latents a decoded picture, and the variational picture autoencoder has the picture-to-latents encoder for deriving from a picture to be encoded unquantized latents, the latent quantizer for quantizing the unquantized latents to obtain the quantized latents, a hyperencoder for deriving a representation of the statistical entropy-coding parameters from the unquantized latents, a hyper quantizer for quantizing the representation of the statistical entropy-coding parameters to obtain the quantized hyperprior from which the statistical entropy-coding parameters are derivable by the hyperdecoder, an entropy encoder for encoding the quantized latents into the data stream using the statistical entropy-coding parameters, wherein a parametrization of the latents-to-picture decoder lies in a minimum of a distortion function from a quantized latent domain to distortion with respect to parameters of the latents-to-picture decoder and/or wherein a parametrization of a hypercoder system having the hyperdecoder and the hyperencoder lies in a minimum of a rate-distortion Lagrangian function from an unquantized-latents-and-quantized-latents domain to a Lagrangian sum of rate and distortion with respect to parameters of the hyperdecoder and the hyperencoder and fixedly with respect to the parametrization of the latents-to-picture decoder.

In accordance with a first aspect of the present inventive concept, an apparatus for further training a pre-trained version of a decoder fitting to a variational picture autoencoder is provided. The decoder comprises a hyperdecoder for deriving, e.g. by means of a neural network, called e.g. hyperdecoder network, statistical entropy-coding parameters which are, in the specific embodiments described herein below called \hat{μ} and \hat{σ}, from a quantized hyperprior in a data stream called exemplarily ŷ in the embodiments outlined below. The quantized hyperprior may, for instance, be coded into, and be decoded from, the data stream using entropy decoding. note that the parametrizable probability density function based on which the quantized hyperprior is coded into the data stream, might be trained along with the hypercoder system comprising hyperdecoder and hyperencoder. in embodiments described further below, this probability density function and its parameters are called ω_{hpmf}). The decoder further comprises an entropy decoder for decoding quantized latents exemplarily called \hat{z} below from the data stream using the statistical entropy-coding parameters. For instance, for each latent (or each coefficient of the latents) or, in even different terms, for the quantization index of each latent/coefficient, the probability mass function used to arithmetically encode the respective value, might be determined based on the statistical entropy-coding parameters. And even further the decoder comprises a latents-to-picture decoder for deriving from the quantized latents a decoded picture. The latents-to-picture decoder may be embodied as a neural network comprising one or more convolutional layers, and the latents may describe the picture in terms of features at one or more block levels or spatial accuracies. The apparatus provided is then configured to provide a training set of training data elements corresponding to a set of various test pictures, each training data element comprising quantized latents resulting from applying the variational picture autoencoder to an associated test picture, and train the latents-to-picture decoder on the training set with respect to distortion optimization to obtain a further trained version (e.g. called

$${ω}_{dec}^{*}$$

below) of the latents-to-picture decoder.

It is an idea underlying the present invention according to the first aspect that it is possible to achieve a more efficient picture autoencoding codec by obtaining a further trained version of the latents-to-picture decoder by retraining the latents-to-picture decoder using the quantized latents resulting from the picture-to-latents encoder. During the training process of a pair of variational picture autoencoder and corresponding decoder, the real quantization values of the latens cannot be used in a straight forward manner such as by use of a gradient descent method due to the quantization function being zero gradient almost everywhere. Due to this, inherent characteristic gradient based training algorithms are not applicable for these models directly. Noise perturbation, straight-through estimation and similar other approximations could be used in order to train these models nevertheless. However, while the substitutions associated with these approaches principally allow the training by taking into account the latents quantization, the inventors found out that it is possible to further train the decoder or, according to an embodiment, the latent-to-picture decoder along with the hypercoder system using the quantized latents to obtain a further trained version of the latents-to-picture decoder, i.e. one showing an improved coding efficiency, namely by providing a training set of training data elements corresponding to a set of various test pictures, each training data element comprising quantized latents resulting from applying the variational picture autoencoder (or, to be more precise, the picture-to-latents encoder thereof) to an associated test picture, and training the latents-to-picture decoder on this training set with respect to distortion optimization.

Thus, embodiments as described herein allow the individual training of only the latents-to-picture decoder or optionally with the hypdercoder system, without the need to train the variational picture autoencoder. This results in the apparatus being able to utilize the real quantized latents without the need of a substitution of any kind of the quantization function for training the decoder. Hence, the underlying quality of the training data used for training the decoder is increased, resulting in the further trained version (e.g., the parameters

$${ω}_{dec}^{*} )$$

of the latents-to-picture decoder which is better accustomed to the task of decoding pictures from the quantized latents.

Furthermore, embodiments as described herein may allow a split of the determination of the quantized latents of the training set and the training of the decoder on the training set. This separation may support more efficient training implementations on modern processing units, such as GPUs. For instance, training variational autoencoders may entail GPUs, but the VRAM limitations of these GPUs might constrain the process due to the high number of parameters involved. Storing the entire parameter set for both the encoder and decoder, along with a portion of the dataset, as occurring in the straightforward training of the pair of autoencoder and corresponding decoder presents a significant challenge when training neural network-based encoding and decoding architectures. Embodiments as described herein, however, may only entail the storage of encoder parameters during the quantized latent determination and decoder parameters during training. This minimizes VRAM usage, enabling more efficient training and data transfer to and from the GPU(s). Consequently, it supports larger batch sizes and improves overall training efficiency.

To conclude, by using embodiments of this invention, a more accurate decoder can be obtained with more possibilities during training, thereby. leading to better coding results and less time and energy consumed during the training.

In accordance an embodiment, the apparatus may be configured to provide the training set by, for each training data element, applying a picture-to-latents encoder and a latent quantizer of the variational picture autoencoder onto a corresponding test picture of the set of various test pictures, the variational picture autoencoder comprising the picture-to-latents encoder for deriving from a picture to be encoded unquantized latents, the latent quantizer for quantizing the unquantized latents to obtain the quantized latents, a hyperencoder for deriving a representation of the statistical entropy-coding parameters from the unquantized latents, a hyper quantizer for quantizing the representation of the statistical entropy-coding parameters to obtain the quantized hyperprior from which the statistical entropy-coding parameters are derivable by the hyperdecoder, an entropy encoder for encoding the quantized latents into the data stream using the statistical entropy-coding parameters, wherein the variational picture autoencoder is configured to write the quantized hyperprior into the data stream. The encoder may, thus, comprise a hyperdecoder which equals the hyperdecoder in the decoder as far as the mapping from quantized hyperprior to statistical entropy-coding parameters is concerned, but may lack, compared to the latter, for instance, functions in the hyperdecoder of the decoder related to the derivation of the hyperprior from the data stream. According to an embodiment, each training data element in the apparatus may further comprise an encoding rate (36i) of the quantized latents, for example a bit length needed by entropy coded portions of the data stream having the quantized latents encoded thereinto plus bit length of the portion of the data stream having the associated quantized hyperprior coded thereinto.

According to an embodiment, the apparatus may be configured to provide a further training set of further training data elements corresponding to a further set of various test pictures, each further training data element comprising unquantized latents and quantized latents resulting from applying the variational picture autoencoder to an associated test picture, and train a hypercoder system comprising the hyperdecoder and a hyperencoder of the variational picture autoencoder on the further training set with fixedly using the further trained version of the latents-to-picture decoder with respect to rate-distortion optimization to obtain a further trained version of the hyperdecoder and a further trained version of the hyperencoder. According to this embodiment, the coding results can be further improved by further training the hyperdecoder system. By using the quantized latents instead of noise perturbation, straight-through estimation or similar other approximation methods to obtain the latents during training, a higher quality further training set may be generated, thereby, leading to better coding results of the further trained version of the hyperdecoder and the further trained version of the hyperencoder.

The method of re-training the hypercoder system may achieve additional coding gain also when the initial latents-to-picture decoder instead of the further trained version is used.

According to a second aspect of the present invention an apparatus may be configured for further training a pre-trained version of a decoder fitting to a variational picture autoencoder, the decoder comprising a hyperdecoder for deriving statistical entropy-coding parameters which are, in the specific embodiments described herein below called e.g., \hat{μ} and \hat{σ}, from a quantized hyperprior, called exemplarily ŷ in the embodiments outlined below in a data stream. The decoder further comprises an entropy decoder for decoding quantized latents exemplarily called \hat{z}, from the data stream using the statistical entropy-coding parameters, and a latents-to-picture decoder for deriving from the quantized latents a decoded picture. The apparatus provided is then configured to provide a further training set of further training data elements corresponding to a further set of various test pictures, each further training data element comprising unquantized latents and quantized latents resulting from applying the variational picture autoencoder to an associated test picture, and train a hypercoder system (also sometimes called hypersystem; note that the PDF for de/encoding the quantized hyperprior might also by further trained) comprising the hyperdecoder and a hyperencoder of the variational picture autoencoder on the further training set with respect to rate-distortion optimization to obtain a further trained version of the hyperdecoder and a further trained version of the hyperencoder.

It is an idea underlying the present invention according to the second aspect that it is possible to achieve a more efficient picture autoencoding codec by obtaining a further trained version of the hyperdecoder and a further trained version of the hyperencoder by retraining them using the quantized latents resulting from the picture-to-latents encoder. During the training process of a pair of a variational picture autoencoder, a corresponding decoder and a corresponding hypercoder system, the real quantization values of the latens cannot be used in a straight forward manner such as by use of a gradient descent method due to the quantization function being zero gradient almost everywhere. Due to this, inherent characteristic gradient based training algorithms are not applicable for these models directly. Noise perturbation, straight-through estimation and similar other approximations could be used in order to train these models nevertheless. However, while the substitutions associated with these approaches principally allow the training by taking into account the latents quantization, the inventors found out that it is possible to further train the hypercoder system using the quantized latents to obtain a further trained version of the hyperencoder and a further trained version of the hyperdecoder, i.e. one showing an improved coding efficiency, namely by providing a training set of training data elements corresponding to a set of various test pictures, each training data element comprising unquantized latents and quantized latents resulting from applying the variational picture autoencoder (or, to be more precise, the picture-to-latents encoder thereof) to an associated test picture, and training the hyperencoder and hyperdecoder on this training set with respect to distortion optimization.

The training of the latents-to-picture decoder according to the first aspect and the training of the hypercoder according to the second aspect may be applied alternatively, in order to obtain an improved decoder, or an—with respect to the hypercoder—improved autoencoder-decoder pair, sequentially in order to gain an even more improved autoencoder-decoder pair, or may be unified into one training which further trains the latents-to-picture decoder and the hypercoder together in one training starting from a base training of the autoencoder-decoder pair.

According to an embodiment, when training the latents-to-picture decoder and the hypercoder system sequentially, the set of various test pictures may be chosen to equal the further set of various test pictures. Utilizing the same set of test pictures can drastically reduce the efforts in training. However, utilizing different test picture sets may have different advantages in other dimensions than training time.

According to an embodiment the apparatus may be configured to provide the further training set by, for each training data element of the further set, applying a picture-to-latents encoder and a latent quantizer of the variational picture autoencoder onto a corresponding test picture of the further set of various test pictures, the variational picture autoencoder comprising the picture-to-latents encoder for deriving from a picture to be encoded unquantized latents, the latent quantizer or quantizing the unquantized latents to obtain the quantized latents, a hyperencoder for deriving a representation of the statistical entropy-coding parameters from the unquantized latents, a hyper quantizer for quantizing the representation of the statistical entropy-coding parameters to obtain the quantized hyperprior from which the statistical entropy-coding parameters are derivable by the hyperdecoder, an entropy encoder for encoding the quantized latents into the data stream using the statistical entropy-coding parameters, wherein the variational picture autoencoder is configured to write the quantized hyperprior into the data stream. The encoder may, thus, comprise a hyperdecoder which equals the hyperdecoder in the decoder as far as the mapping from quantized hyperprior to statistical entropy-coding parameters is concerned, but may lack. Compared to the latter, for instance, functions in the hyperdecoder related to the derivation of the hyperprior from the data stream.

In accordance with the first aspect of the present inventive concept, a decoder results which fits to a variational picture autoencoder, the decoder comprising a hyperdecoder for deriving statistical entropy-coding parameters (e.g., \hat{μ} and \hat{σ}) from a quantized hyperprior (e.g., ŷ) in a data stream, an entropy decoder for decoding quantized latents (e.g., \hat{z}) from the data stream using the statistical entropy-coding parameters, and a latents-to-picture decoder for deriving from the quantized latents a decoded picture, wherein a parametrization of the latents-to-picture decoder lies in a minimum

$$( e . g . {w}_{dec}^{*} = {arg min}_{{w}_{dec} ; w} D )$$

of a distortion function leading from a quantized latent domain to distortion

$$( e . g . D = {\sum }_{k}^{K} {( {x}_{k} - Dec {( \tilde{z} : {w}_{dec} )}_{k} )}^{2} )$$

with respect to—or parametrized by—parameters of the latents-to-picture decoder.

In accordance with the first or second aspect of the present inventive concept, a system of a variational picture autoencoder and a decoder results, that fits to the variational picture autoencoder, wherein the decoder comprises a hyperdecoder for deriving statistical entropy-coding parameters, exemplarily called y and Q) from a quantized hyperprior, exemplarily called ŷ) in a data stream. The decoder further comprises an entropy decoder for decoding quantized latents, exemplarily called \hat{z}, from the data stream using the statistical entropy-coding parameters, and a latents-to-picture decoder for deriving from the quantized latents a decoded picture The variational picture autoencoder may comprise a picture-to-latents encoder for deriving from a picture to be encoded unquantized latents, a latent quantizer for quantizing the unquantized latents to obtain quantized latents, a hyperencoder for deriving a representation of the statistical entropy coding parameters from the unquantized latents, a hyper quantizer for quantizing the representation of the statistical entropy coding parameters to obtain the quantized hyperprior from which the statistical entropy-coding parameters are derivable by the hyperdecoder, an entropy encoder for encoding the quantized latents into the data stream using the statistical entropy-coding parameters. The encoder may, thus, comprise a hyperdecoder which equals the hyperdecoder in the decoder 10 as far as the mapping from quantized hyperprior to statistical entropy-coding parameters is concerned, but may lack. Compared to the latter, for instance, functions in the hyperdecoder related to the derivation of the hyperprior from the data stream. The system configured such that a parametrization of the latents-to-picture decoder lies in a minimum of a distortion function from a quantized latent domain to distortion with respect to parameters of the latents-to-picture decoder Furthermore, a parametrization of a hypercoder system comprising the hyperdecoder and the hyperencoder lies in a minimum of a rate-distortion Lagrangian function from an unquantized-latents-and-quantized-latents domain to a Lagrangian sum of rate and distortion with respect to parameters of the hyperdecoder and the hyperencoder and fixedly with respect to the parametrization of the latents-to-picture decoder.

### BRIEF DESCRIPTION OF THE FIGURES

In the following, embodiments of the present disclosure are described in more detail with reference to the figures, in which:

FIG. 1 shows a schematic view of a variational picture autoencoder encoding a picture to a bitstream and a latent-to-picture decoder, that may be trained with an inventive concept according to an embodiment, decoding the data stream;

FIG. 2 shows a schematic view of the training according to an embodiment, together with a schematic view of the data that may be used during the training;

FIG. 3 shows a table of BD-Rates of Kodak images encoded with the retrained USQ decoder model according to embodiments compared to a USQ anchor model;

FIG. 4 shows a table of BD-Rates of Kodak images encoded with the retrained TCQ decoder model according to embodiments compared to a TCQ anchor model;

FIG. 5 shows a table of BD-Rates of Kodak images encoded with the USQ model with a retrained hypercoder system and latent-to-picture decoder according to embodiments, compared to a USQ anchor model;

FIG. 6 shows a table of absolute average PSNR differences between the USQ/TCP experiments and their anchor models;

FIG. 7 shows a table of average BD-rates between retrained models and their respective anchors for the TecNick test dataset; and

FIG. 8 shows a table of absolute average PSNR differences between the USQ/TCQ experiments and their respective anchor models on the Kodak and TecNick dataset.

### DETAILED DESCRIPTION OF THE INVENTION

Equal or equivalent elements or elements with equal or equivalent functionality are denoted in the following description by equal or equivalent reference numerals.

Method steps which are depicted by means of a block diagram and which are described with reference to said block diagram may also be executed in an order different from the depicted and/or described order. Furthermore, method steps concerning a particular feature of a device may be replaceable with said feature of said device, and the other way around.

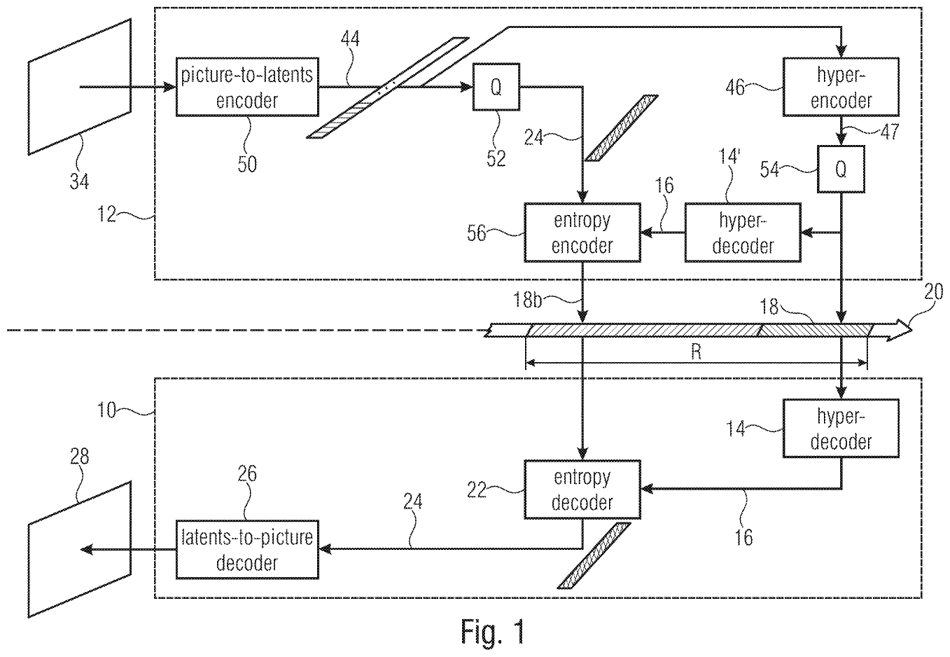

In the following, a variational picture autoencoder decoder model will be described, taking reference to FIG. 1.

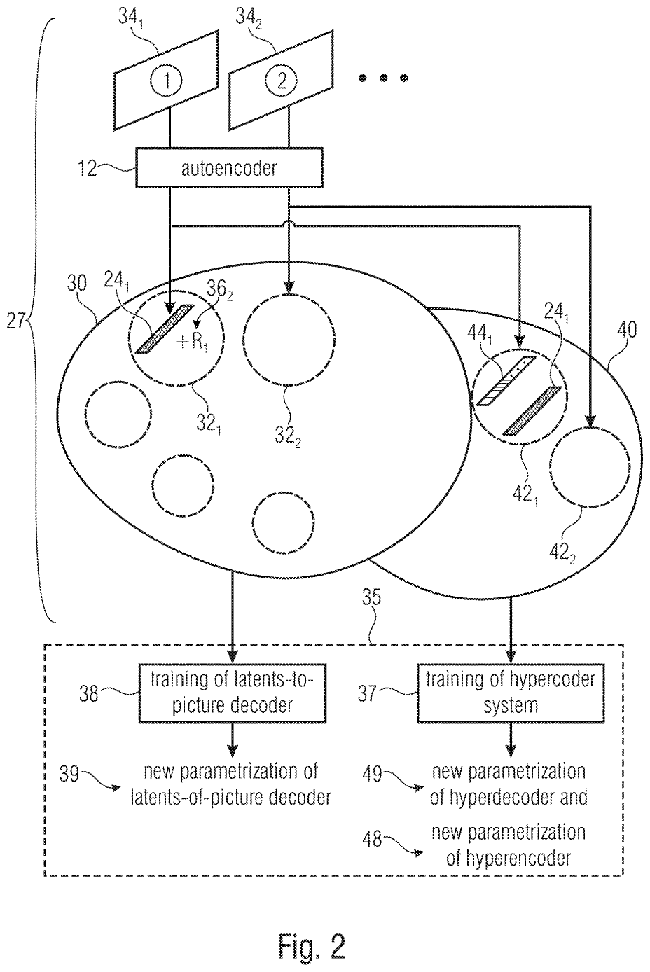

FIG. 1 exemplarily illustrates a variational picture autoencoder 12 encoding a picture 34 into a data stream 20 and a decoder 10 decoding the bitstream 20 to obtain a decoded picture 28, wherein the decoder 10 may be trained according to an embodiment of this invention. It is to be noted, that the picture 34 may be an arbitrary picture to be coded or correspond to a test picture 34i according to FIG. 2 selected to from part of a training set as described further below.

The variational picture autoencoder 12 comprises a picture-to-latents encoder 50, a latent quantizer 52, a hyperencoder 46, a hyper quantizer 54, a hyperdecoder 14′ and an entropy encoder 56. The picture-to-latents encoder 50 is configured to obtain unquantized latents 44 on the basis of the test picture 34. The latents are derived in a manner so as to “describe” the picture 34 and may be interpreted as a feature description. The mapping from picture 34 to the unquantized latents 44 may reduce the amount of data or, to be more precise, the dimensionality. The unquantized latents 44 are subject to quantization by the latent quantizer 52 to obtain quantized latents 24 and are processed by the hyperencoder to obtain a representation 47. The hyper quantizer 54 obtains a quantized hyperprior 18 by subjecting the representation 47 to quantization. The quantized hyperprior 14′ is subject to processing by the hyperdecoder 14′ which maps the quantized hyperprior 14′ onto statistical entropy-coding parameters 16. For example, the statistical entropy-coding parameters 16 may comprise central tendency measures and dispersion measures used for entropy coding.

The entropy encoder is configured to generate one part 18b of the data stream 20, namely by using the statistical entropy-coding parameters 16 so as to encode the quantized latents 24 into the part 18b. Another part 18a of the data stream 20 receives the quantized hyperprior 18 from the hyperquantizer 54 which, thus, writes the hyperprior into the data stream 20 or part 18a, respectively.

The decoder 10 may be configured to decode the decoded picture 28 from the data stream 20. The decoder 10 comprises a hyperdecoder 14, an entropy decoder 22 and a latents-to-picture decoder 26. For example, the hyperdecoder 14 may be configured to obtain the statistical entropy-coding parameters 16 on the basis of the quantized hyperprior 18 in the datastream 20. With respect to the mapping from the quantized hyperprior 18 to the statistical entropy-coding parameters 16, hyperdecoder 14 and hyperdecoder 14′ may coincide. For example, the entropy decoder 22 is configured to decode the quantized latents 24 from the data stream 20 using the statistical entropy-coding parameters 16. It is to be noted, that the entropy encoder 22 may, for example, be an arithmetic decoder. Finally, the latents-to-picture decoder 26 is configured to derive the decoded picture 28 from the quantized latents 24.

It should be noted that the codec of autoencoder 12 and corresponding decoder 10 is merely representative and that the embodiments described herein may also be transferred onto codecs deviating from the description brought forward with respect to FIG. 1.

In the following, a concept for further training parts of the autoencoder 12 and the decoder 10 are described by taking reference to FIG. 2. That is, the training of FIG. 2 starts from a state where the autoencoder 12 and the decoder 10 are already (pre)trained with FIG. 2 and the following description revealing different embodiments to further train parts of the autoencoder 12 and the decoder 10 such as latents-to-picture decoder 26 and/or the hypercoder system composed of hyperdecoder 14′/14 and hyper encoder 46 and, optionally, hyperquantizer 54.

In a first aspect of the FIG. 2, the concept comprises a providing 27 of a training set 30 and a training 38 of latents-to-picture decoder 26. The training set 30 comprises one or more training data elements 32i, exemplary depicted with test data element 321 and test data element 322. The training data element 32i comprises quantized latents 24i and an encoding rate 36i, that relate to a test picture 34i. The quantized latents 24i and the encoding rate 36i can be derived from the test picture 34i by applying latents to picture encoder 50 and latent quantizer 52 to the test picture 34i. The encoding rate 36i may, for example, be a bit length needed by entropy coded portions of the data stream 20 having the quantized latents 24 encoded thereinto plus bit length of the portion of the data stream 20 having the associated quantized hyperprior coded thereinto. It should be noted that FIG. 2 indicates the quantized latents 24i and the encoding rate 36i as stemming from the autoencoder 12 as if they were output by the autoencoder, but in fact, the quantized latents 24i and the encoding rate 36i are simply gained from the application of the autoencoder 12 onto the test pictures. The training set 30 obtained by the provision 27 can be utilized by the training 38 of the latents-to-picture decoder 26 to obtain a new parameterization of the latents-to-picture decoder 26, resulting in a further trained version 39 of the latents-to-picture decoder 26. It is to be noted, that for training 38 the latent-to-picture decoder 26, the model input is based on the quantized latents 24i and the encoding rate 36i. Therefore, there is no need for an autoencoder 12 during the training 38. The training may be done using a gradient based optimization method to minimize a cost function, that may relate to a distortion measure of the test picture 34i and the decoded picture 28 of the decoder 10 for said test picture 34i.

In a second aspect, FIG. 2 exemplarily illustrates an alternative or inclusive training 37 of the hypercoder system. With respect to this second aspect, FIG. 2 depicts a providing 27 of a further training set 40, that comprises one more further test data elements 42i, exemplary depicted with further test data element 421 and a further test data element 422. The further training data element 42i comprise unquantized latents 44i and quantized latents 24i that can be obtained by applying picture-to-latents encoder 50 and latents quantizer 52 to the test picture 34i, respectively. The training 37 of the hypercoder system utilizes the further training data set 40 obtained by the provision 27 for training 37 of hypercoder system, resulting in a new parameterization of hyperdecoder 14/14′, resulting in a further trained version 49 of the hyperdecoder 14/14′ and a new parameterization of hyperencoder 46, resulting in a further trained 48 version of the hyperencoder 46. Optionally the training 37 may comprise the training of the hyperquantizer 54, with which a further trained version of the hyperquantizer 54 may be obtained. Furthermore, it is to be noted, that the parametrization of the hypercoder system may, for example, be optimized using a cost function defined by a Lagrangian cost function of a picture distortion measure and a coding rate measure.

The training of parts of the autoencoder 12 and the decoder 10 may be done sequentially with the training 38 of the latents-to-picture decoder 26 done in a separate step before or after the training 37 of the hypercoder system. By fixing the weights of the latents-to-picture decoder 26 the hypercoder system can be trained 37 separately to the latents-to-picture decoder 26. The other way round, by fixing the weights of the hypercoder system in the decoder 10, specifically the hyperdecoder 14, the latents-to-picture decoder 26 can be trained 38. Additionally, the weights of the latents-to-picture decoder 26 and the weights of the hyper coder system may be open to optimization and the parts of the autoencoder 12 and the decoder 10 may be trained 35 simultaneously. When training 35 parts of the autoencoder 12 and the decoder 10 are trained, namely the latents-to-picture decoder 26, the hyperencoder 46, the hyperdecoder 14 and optionally the hyperquantizer 54. For example, when using a gradient based method to further train 38 the latent-to-picture decoder 26 the gradient may be passed through to the hypercoder and the weights of the hypercoder system may be adjusted in the same training step as the latents-to-picture decoder 26. This flexibility allows a better customization of the training to the present optimization requirements and goals.

Furthermore, it is to be noted, that according to an embodiment the training set 30 and the further training set 40 may relate to the same test pictures 34i but don't necessarily have to.

An apparatus according to an embodiment of this invention, configured train 37 or train 35, may, for example, be configured to output the further trained 48 version of the hyperencoder 46 at an output of the apparatus, in order for an update of the variational picture encoder.

One or more of the concepts presented in FIG. 2 may be implemented as an apparatus or as a method. Furthermore, it is noted, that the training 35/37/38 are merely exemplarily depicted and that the embodiments described herein may also be transferred onto other training approaches deviating from the description brought forward with respect to FIG. 2.

For a decoder trained according to the concept involving training 38, the following may be applicable or, the following may be true. In particular, the decoder's 10 neural network parameters are generated, by way of the further training, in a manner so that specific statements are true for its parametrization of the latents-to-picture decoder. For example, for a typical set of typical quantized latents 24 generated by the variational autoencoder (e.g., by quantizer 52), i.e. generated thereby on typical/representative pictures, on average, a partial derivative of the distortion function having the typical (or representative) quantized latents 24 inserted, with respect to the parameters of the latents-to-picture decoder 26, e.g. its weights, i.e. the vector of partial derivatives of said function with respect to each of the network parameters, yields zero or is very close thereto; for example, a suitable norm of the vector is smaller than 0,01. Alternatively, for a typical set of a typical quantized latents 24 generated by the variational autoencoder (e.g., by quantizer 52), i.e. generated thereby on typical/representative pictures, trying to further train the latents-to-picture decoder based on this typical set would reveal that the latents-to-picture decoder 26 is already trained in this regard and this further training 38 is, thus, already in saturation so that, for instance,
2a) after one complete training round the parameters of the latents-to-picture decoder 26 change, measured by taking, for instance, a suitable norm of a difference of a vector of these parameters in their original version and a vector of these parameters after the one round, less than a predetermined measure such as 1% of a mean of absolutes of the parameters in their original version), or
2b) after one complete training 38 round an absolute difference of the mean of distortions for the typical set obtained with the parametrization of the latents-to-picture decoder 26 before the one round and the mean of distortions for the typical set obtained with the parametrization of the latents-to-picture decoder 26 after the one round is smaller than a predetermined value such as 1% of the mean of distortions for the typical set obtained with the parametrization of the latents-to-picture decoder 26 before the one round; here, the typical set may, for instance, comprise 100 pictures which might be randomly selected, or may be defined by the set of pictures defined in J. Deng, W. Dong, R. Socher, L. -J. Li, Kai Li and Li Fei-Fei, “ImageNet: A large-scale hierarchical image database,” 2009 IEEE Conference on Computer Vision and Pattern Recognition, Miami, FL, USA, 2009, pp. 248-255, doi: 10.1109/CVPR.2009.5206848 or as defined as one of the JPEG AI Dataset such as the training dataset, the validation dataset or the test dataset in JPEG AI: ISO/IEC JTC 1/SC29/WG1 N100600, CPM “JPEG AI Common Training & Test Conditions v8.0, 100th Meeting, Covilhã, Portugal, July 2023, available at https://jpeg.org/jpegai/documentation.html; further, the norm mentioned above might be the 2-norm; as the distortion, the sum of sample-wise difference between the original picture and the decoded picture might be used; the parameters thus used for determining whether the latents-to-picture decoder is already trained in this manner might be the weights of the neural network of the latents-to-picture decoder.

The same may hold true for a system comprising a decoder trained according to the concept involving the training 38.

For a system trained according to the concept involving training 37, the following may be applicable or, the following may be true. In particular, the decoder's 10 neural network parameters are generated, by way of the further training, in a manner so that specific statements are true for its parametrization of the latents-to-picture decoder. The function of interest is the rate-distortion Lagrangian function and the parameters of interest are those of the hyperdecoder and hyperencoder; that is:
1) for a typical set of a typical unquantized latents 44 and their quantized version, i.e. the quantized latents 24, as generated by the variational autoencoder (e.g., the quantizer 52), i.e. generated thereby on typical/representative pictures, on average, a partial derivative of the rate-distortion Lagrangian function having the typical (or representative) quantized (e.g., quantized latents 24) and unquantized latents 44 inserted, with respect to the parameters of the hypercoder system (e.g. including the hypercoder system's PDF for entropy coding the hyperprior), e.g. its weights, i.e. the vector of partial derivatives of said function with respect to each of the network parameters yields zero or is very close thereto; for example, a suitable norm of the vector is smaller than 0,01; or
2) for the typical set, trying to further train the hypercoder system based 5 on this typical set reveals that the hypercoder system is already trained in this regard and this further training is, thus, already in saturation so that, for instance,
2a) after one complete training round the parameters of the hypercoder system change, measured by taking, for instance, a suitable norm of a difference of a vector of these parameters in their original version and a vector of these parameters after the one round, less than a predetermined measure such as 1% of a mean of absolutes of the parameters in their original version), or
2b) after one complete training round an absolute difference of the mean of distortions for the typical set obtained with the parametrization of the hypercoder system before the one round and the mean of distortions for the typical set obtained with the parametrization of the hypercoder system after the one round is smaller than a predetermined value such as 1% of the mean of distortions for the typical set obtained with the parametrization of the hypercoder system before the one round; here, the typical set may, for instance, comprise 100 pictures which might be randomly selected, or may be defined by the set of pictures defined in one of the above datasets mentioned in the comment on claim 17; further, the norm mentioned above might be the 2-norm; in the Lagrangian function, for the distortion, the sum of sample-wise difference between the original picture 34 and the decoded picture 28 might be used and for the rate summand, a sum of logarithms of probabilities for the quantized latent 24 as determined by means of the representation 47 of the statistical entropy-coding parameters 16, i.e. the unquantized hyperprior, modified to simulate the hyperprior quantization, plus a sum over logarithms of probabilities of the elements of the unquantized hyperprior, again in the version modified to simulate the hyperprior quantization; the parameters thus used for determining whether the hypercoder system is already trained in this manner might be the weights of the neural network of the hypercoder system.

The following may be titled further training of a pre-trained version of a decoder fitting to a variational picture autoencoder.

This application is about optimizing deep learned image compression on true quantization.

Preferred embodiments are described first with then presenting broadened embodiments derived therefrom and claims.

The following may be titled abstract.

The continuous improvements on image compression with variational autoencoders (VAEs) have led to learned codecs that outperform conventional approaches in terms of rate-distortion efficiency. Nonetheless, taking quantization into account during the training process remains a problem, since the actual quantization has zero derivatives nearly everywhere, and thus needs to be replaced with a differentiable approximation that allows end-to-end training. Even though different methods may be able to approximate the encoder (e.g., the variational picture encoder 12) quantization (e.g., with the latent quantizer 52) to a reasonable degree, none of them model the quantization noise correctly and, thus, result in suboptimal networks. We propose a two-stage training process: After a conventional training, parts of the network are retrained according to embodiments of this invention (e.g., training 38, training 37 or training 35) where quantized latents (e.g., the quantized latent 24i) are obtained by an actual quantization. This training modification consistently improves coding efficiency, demonstrating that a conventional approximation of quantization yields suboptimal networks. For the Kodak test set, we obtained average bitrate savings of 1% to 2%. Embodiments of the present invention may relate to one or more of the following terms: Deep-Learning, Image Compression, Auto-Encoder, Quantization, Rate-Distortion-Optimization, Trellis-Coded-Quantization.

The following may be titled introduction.

Compressing images using neural networks has developed into a promising coding technique [1], [2], offering alternatives to modern coding standards like VVC [3] or HEVC [4], while achieving similar or even better compression performance. Variational Autoencoders (VAEs) [5] first nonlinearily transform the input image into latents, which are then may be quantized (e.g., with a latent quantizer 52) and entropy coded (e.g., with an entropy encoder 56) with conventional methods like arithmetic coding [6]. The decoder (e.g., the decoder 19) may perform another nonlinear transform to reconstruct an approximation of the input image (e.g., a test image 34). The entropy coding (e.g., with the entropy encoder 56) process usually utilizes another nonlinear network to estimate the probability distributions of the quantized latents (e.g., quantized latents 24), which then may be used in the arithmetic coder. A possible approach for this estimation is applying a hypercoder network [7], [8], which may further compress the latents (e.g., the unquantized latents 44) into side information which can be transmitted together with the quantized latents (e.g., the quantized latents 24). The distributions of the latent variables may be approximated as normal distributions and the transmitted side information may be used by both encoder (e.g., variational picture encoder 12) and decoder (e.g., decoder 10) to calculate estimated mean and variance values. The arithmetic coder (e.g., entropy encoder 56) may use the probabilities that are obtained by quantizing the estimated normal distributions, which may vastly improve overall rate-distortion performance. This basic approach can, for example, be further improved by incorporating autoregressive probability estimation, or by using transmitted side information to estimate the parameters of more complex distribution models [9], [10]. The models are trained using an end-to-end-approach, allowing the different parts of the neural network to be optimized jointly with respect to minimizing the rate-distortion cost [11]. However, taking quantization into account during the end-to-end training process is nontrivial. Quantization functions such as uniform scalar quantization (USQ) or trellis coded quantization (TCQ) [12], [13] have zero gradients almost everywhere, impeding the backpropagation of the learning process with respect to the weights of the encoding network and therefore disallowing end-to-end training. Hence, quantization is usually replaced with an approximation of its impact on the latents. Previous approaches utilize noise perturbation [7], [8], [14], straight-through estimation [15], [16], and similar other approximations [17]-[19]. The findings of [19] in particular indicate that there is no single optimal approximation, but that different approximations may work better for different network architectures.

Embodiments of this invention aim to circumvent the approximation step by using a conventionally trained model as an anchor, and retraining (e.g., training 35, training 37 or training 38) parts of the neural network with real quantized data (e.g., training set 30, or training set 40). Using the same quantization for training as in the actual encoder (e.g., variational picture encoder 12) prevents gradient passthrough to the encoder network (e.g., the picture-to-latents encoder 50). Thus, an adequately pretrained model is used as a basis, the training loss of which has already saturated, and applicable parts of the model are then further retrained (e.g., by using the training 38, training 37 or training 35) using embodiments of this invention.

In particular, we optimize the decoder network with respect to the distortion by applying the actual quantization function (e.g., with the latent quantizer 52) to the latents (e.g., the unquantized latents 44) provided by the pretrained encoder (e.g., a picture-to-latents encoder 50). As the hypercoder network computes estimates for the means and variances of the unquantized latents (e.g., unquantized latents 44), it may, for example, be retrained (e.g., training 37, training 35) as well, with respect to minimizing the cross entropy of the quantized latents (e.g., the quantized latents 24).

We show that allowing the decoder (e.g., the decoder 10) to retrain (e.g., using the training 38, training 37 or training 35) on truly quantized latents (e.g., the quantized latents 24) leads to improvements even for more complex quantization methods than USQ. In particular, we test our retraining method (e.g., using the training 38, training 37 or training 35) for a 4-state TCQ implementation, and achieve higher relative BD-rate gains [20] than for USQ, which indicates that complex quantization methods may be harder to approximate with differentiable functions during the training process [12].

The following may describe the architecture of the proposed VAE structure, the different considered quantization approaches, and how those may, for example, be substituted in the training process.

The following may be titled network architecture.

The following may describe general autoencoder.

The network used in embodiments of this invention is based on the autoencoders of [11], [12] and may follow the basic architecture of VAEs, where an input image x is transformed by an encoder network (e.g., a picture-to-latents encoder 50) to the latent (e.g., the unquantized latents 44) representation z∈ [symbol] , where N describes the total number of latent coefficients (e.g., the cardinality unquantized latents 44) A quantization function is then applied (e.g., by the latent quantizer 52), converting the latents (e.g. the unquantized latents 44) to quantization indices q∈ [symbol] (e.g., the quantized latents 24), usually symmetric around the estimated means \hat{μ}. At the decoder (e.g., the decoder 10) side, the quantization indices are dequantized into the reconstructed latent z∈ [symbol] , which can then be transformed by a decoder network (e.g., by a latents-to-picture decoder), yielding the approximation \hat{x} of the input image (e.g., a decoded picture 28):

$$z = Enc ( x ; {w}_{enc} ) , \qquad ( 1 )$$

$$q = Q ( z , \hat{μ} ) ,$$

$$\hat{z} = DQ ( q , \hat{μ} ) ,$$

$$\hat{x} = Dec ( \hat{z} ; {w}_{dec} ) .$$

As with most VAE implementations, encoder (e.g., a variational picture encoder 12) and decoder (e.g., a decoder 10) networks according to embodiments of this invention are based on convolutional layers and GDN nonlinearities [21], the trainable weights of which being represented by w_{enc} for the encoder and w_{dec} for the decoder. Additionally, octave convolutions in three different resolution levels similar to [22] to further reduce spatial redundancies in the latent representation may be utilized in embodiment of this invention. For transmitting the quantization indices q (e.g., the quantized latents 24) with an arithmetic coder (e.g., with the entropy encoder 56), a hypercoder network may be applied to the latents (e.g., the unquantized latents 44) to estimate the probability distributions for the arithmetic coding process. The hypernetwork may create the hyperprior (e.g., the hyperprior 47) y from the unquantized latent (e.g., unquantized latents 44) z and quantizes (e.g., using the hyper quantizer 54) the hyperprior (e.g., the hyperprior 47) to ŷ with

$$y = {Enc}_{hyper} ( z ; {w}_{hypenc} ) , \qquad ( 2 )$$

$$\hat{y} = ⌊ y ⌉ .$$

The hyperdecoder (e.g., hyperdecoder 14) network may use the quantized hyperprior (e.g., quantized hyperprior 18) ŷ to generate estimates \hat{μ} and \hat{σ} of the mean and the standard deviation for each coefficient of z:

$$\hat{μ} = {Dec}_{hyper} ( \hat{y} ; {w}_{hypdec}^{mean} ) , \qquad ( 3 )$$

$$\hat{σ} = {Dec}_{hyper} ( \hat{y} ; {w}_{hypdec}^{dev} ) .$$

According to embodiments of this invention, it may be assumed that the unquantized latents (e.g., unquantized latents 44) are normal distributed. Then, for each entry qᵢ of the quantization indices (e.g., the quantized latents 24) q, the probability mass function (pmf) used for arithmetic coding may be obtained by quantizing the Gaussian distribution N(\hat{μ}\hat{σ}) according to:

$$P ( {q}_{i} \vert ( {\hat{μ}}_{i} , {σ}_{i} ) ) = {\int }_{a}^{b} 𝒩 ( t ; {\hat{μ}}_{i} , {\hat{σ}}_{i}^{2} ) dt , \qquad ( 4 )$$

here the integration limits are:

$$a = DQ ( {q}_{i} , {\tilde{μ}}_{i} ) - Δ / 2 , \qquad ( 5 )$$

$$b = DQ ( {q}_{i} , {\tilde{μ}}_{i} ) - Δ / 2.$$

Here, Δ denotes the quantization step size. The hyperprior (e.g., hyperprior 47) ŷ may likewise be encoded by the arithmetic coder, its distribution may be estimated by a learned, static probability distribution P_{hyp}(·|w_{hpmf}) with the learned weights w_{hpmf}, and a step size of Δ=1, as demonstrated in [7]. All weight variables used in the network will be collectively referred to as:

$$w = [ {w}_{enc} , {w}_{doc} , {w}_{hypenc} , {w}_{hpmf} , {w}_{hypdec}^{mean} , {w}_{hypdec}^{dev} ] . \qquad ( 6 )$$

The following may be titled quantization functions.

In most VAE designs, USQ is chosen for quantization at inference. For example, in the latent quantizer 52, the latents (e.g., the unquantized latents 44) are quantized by dividing each value by the quantization step size Δ and rounding the result to the next integer; the dequantization process then maps the quantization indices to the uniformly spaced reconstruction levels:

$$q = {Q}_{USQ} ( z , \hat{μ} ) = ⌊ ( z - \tilde{μ} ) / Δ ⌉ , \qquad ( 7 )$$

$$\hat{z} = {DQ}_{USQ} ( q , \hat{μ} ) = q \cdot Δ + \hat{μ} .$$

Note that during inference, according to embodiments, the estimated mean \hat{μ} is subtracted before the quantization, and add it back after the dequantization. Particularly for low-rate operation points, at which many values are quantized to zero, this typically decreases the average quantization error. Some approaches use more advanced quantizers, such as TCQ [12], [13], which represents a complexity-constrained vector quantizer [23]. Embodiments of this invention may follow the TCQ design (e.g., for quantizer 52 and/or for hyperquantizer 54) of [12], [24], where from a decoder (e.g., decoder 10) perspective, TCQ employs two distinct scalar quantizers and a state transition table, by which the quantizer used for a current latent is selected based on the parities of the preceding quantization indices. Given a measure of the rate-distortion cost per quantization index, the possible encoder (e.g., variational picture encoder 10) decisions can be represented by a trellis structure. The Viterbi algorithm then solves the encoding problem of finding the rate-distortion-optimal path through the trellis [25]. The rate is calculated with the estimates y and 8, which are used to compute probability tables for each quantizer with their distinct quantization intervals, and the distortion in the reconstruction caused by the quantization is estimated by using the latent distortion.

The following may be titled pretraining.

When initially training the entire VAE network, the quantization function may be replaced with a differentiable approximation to allow for useful gradients to be calculated for the encoder (e.g., variational picture encoder 12) network. For VAEs meant to use USQ during inference, a usual replacement [14] is adding uniform white noise onto the latents (e.g., the unquantized latents 44), simulating the average perturbation caused by true quantization:

$$\tilde{z} = {Q}_{noise} ( z ) = z + 𝒰 ( - \frac{Δ}{2} , \frac{Δ}{2} ) . \qquad ( 8 )$$

This process is based on the assumption that the perturbations caused by real quantization are uniformly distributed, though it can be argued that this representation is too simple and not realistic enough to allow for optimal training. The approximation process for TCQ as described in [12] similarly perturbs the latent with uniformly distributed white noise, however choosing between two different perturbations

$${\tilde{z}}_{i}^{0} := z + 2 \cdot Δ \cdot 𝒰 ( - {0}^{⌣} \text{.5} , 0.5 ) and$$

$$\underline{{\tilde{z}}_{i}^{1}} := {\tilde{z}}_{i}^{0} - \hat{sgn} ( {z}_{i}^{0} ) Δ ,$$

whichever is closer to the original zᵢ. This aims to approximate the complicated decision process of the Viterbi algorithm in the training. The approximated dequantized latent \tilde{z} is then used for the decoding process.

Similarly, the quantization of the hyperprior (e.g., the representation 18) with its fixed quantization step size of Δ=1 is approximated by:

$$\tilde{y} = y + 𝒰 ( - 0.5 , 0.5 ) . \qquad ( 9 )$$

The estimated mean and variance parameters (e.g., the statistical entropy coding parameters 16) calculated with the approximately quantized hyperprior (e.g., the quantized hyperprior 18) y are referred to as y and 6, respectively. Using rate-distortion loss as a training objective, the autoencoder network is jointly optimized as follows:

$${w}^{*} = {arg min}_{w} ( D + λ \cdot R ) , \qquad ( 10 )$$

$$where D = {\sum }_{k}^{K} {( {x}_{k} - {Dec ( \tilde{z} ; {w}_{dec} )}_{k} )}^{2} , \qquad ( 11 )$$

with k indexing the samples of the input image of size K, and

$$R = {\sum }_{i}^{N} - {log}_{2} P ( {\tilde{z}}_{i} \vert {\tilde{y}}_{i} ) + {\sum }_{j}^{M} - {log}_{2} {P}_{hyp} ( {y}_{j} \vert {w}_{hpmf} ) , \qquad ( 12 )$$

with i and j sequentially indexing the multidimensional latents (e.g., unquantized latents 44 or quantized latents 24) of size N and hyperpriors (e.g., representation 47) of size M, respectively. The Lagrange multiplier λ may be used to prioritize either a low rate R or a low distortion D, effectively shifting the trained model to high or low bitrate working points. The estimation of the rate is similar to the calculation of the symbol probabilities during inference as described in (4). However, instead of using some actual quantization indices like in (5), the probability distribution may be calculated with the limits of a=\tilde{z}−Δ/2 and b=\tilde{z}+Δ/2. It is implicitly assumed that the arithmetic coder achieves the entropy limit given by the estimated pmfs.

The following may discuss retraining experiments according to embodiments of this invention and presents the results.

The following may be titled Training Experiments Using Real Quantization.

The experimental VAEs were trained on a subset of the Imagenet dataset [26], with cropped 256×256 luma blocks. Test results in inference were calculated on fully sized luma Kodak images [27]. The experiments were implemented, and optimization was performed, through the Tensorflow Deep Learning framework [28]. 250 batches of size 8 (for the USQ models) and 4 (for the TCQ models) were used in one epoch, with a learning range l decreasing from

$$l = \frac{{10}^{- 6}}{1.131}$$

with a decay factor of

$$\frac{1}{1.131} ,$$

running until training loss saturation was achieved. Five VAEs for different working points were trained for each experiment, where each VAE used a different Lagrange parameter of (128, 256, 512, 1024, 2048) to change the rate-distortion-balance. Additionally, the quantization step sizes Δ used by the quantizers were changed, so that lower rate models used larger quantization intervals. For the experiments, two pretrained sets of VAEs were used; the first set consists of networks trained for USQ derived from [11], with quantization approximations consisting of uniform perturbations of the latents (e.g., the unquantized latents 44). The second set is derived from [12], which applied the approximation process described previously designed to approximate the noise two competing quantizers would introduce to the latents (e.g., the unquantized latents 44).

The following may be titled retraining of the decoder

The first experiment according to embodiments of this invention aimed to optimize only the decoder (e.g., the latents-to-picture decoder 26) network w_{dec} of the VAE using actual quantized data (e.g., the quantized latents 24i). For this, the models trained for USQ were retrained according to embodiments of this invention by replacing the quantization approximation function (8) with the true quantization function (7), including the mean shift. The training (e.g., training/train 38) according to embodiments of this invention was then conducted with only the weights of the decoder (e.g., the latent-to-picture decoder 26) w_{dec} being allowed to be adjusted, with the encoder (e.g., the variational picture encoder 12) and the entire hypercoder being effectively frozen. This excludes the rate term from the training process and simplifies the training objective to:

$${w}_{dec}^{*} = {arg min}_{{w}_{dec} \vert w} D . \qquad ( 13 )$$

The BD-rates achieved by this retraining are listed in the table 300. The BD-rate is a measure that compares a PSNR-rate curve (given by a set of data points) against a reference PSNR-rate curve and specifies the average relative rate difference to the reference curve for the same PSNR, where negative values indicated bitrate savings [20]. Retraining (e.g., training 38 or training 35) the decoder (e.g., the latent-to-picture decoder 26) according to embodiments of this invention leads to a BD-rate of −0.87% for high bitrates and −1.24% for low bitrates, meaning that the retraining (e.g., training 38, training 35) improved the model's performance. The models trained for low bitrates generally benefit more from the retraining (e.g., training 38, training 35) with stronger BD-rate gain. A possible explanation of this behavior is that the application of larger quantization step sizes in the quantization approximation (8) conform less to the assumption of uniformly distributed quantization noise than smaller quantization step sizes, leading to a larger approximation error to be corrected through retraining. It is notable that the improvements are consistent over the entire testing dataset, with every operation point being improved by the retraining (e.g., training 38, training 35) according to an embodiment of this invention, and no decreases in quality occurring. Since only the decoder (e.g., the latent-to-picture decoder 26) is retrained (e.g., training 38, training 35), the bitstreams (e.g., the bitstream 20) of the test images are the same as for the pretrained model, and only the reconstruction error decreases. On average, the improvement of the PSNR between the anchor model and the model with the retrained decoder is 0.072 dB.

The following may be titled decoder retraining for TCQ.

In order to test whether a decoder (e.g., a latents-to-picture decoder 26) retraining according to embodiments of this invention is also advantageous for more advanced quantization schemes, the same experiment according to embodiments of this invention was conducted for the TCQ-optimized VAE. Replacing the approximation function with a true TCQ process is nontrivial, so according to embodiments of this invention TCQ was applied offline to the entire dataset, pregenerating a comprehensive pool of TCQ dequantized features 2. This pregenerated dataset was then loaded in for the training process, allowing the decoder (e.g., the latents-to-picture decoder 26) to train on real TCQ data. The experimental results of the retrained decoder for TCQ models in comparison to the original anchor models are listed in the table 400. Similar to the previous experiment, the improvement is consistent over all rate points and test images, with an average BD-rate of −1.97% for high bitrates, and −1.90% for low bitrates. As with USQ, retraining the TCQ decoder only leads to reconstruction improvements. The average PSNR increase of all rate points across the inference dataset is 0.136 dB, with no model decreasing in quality at any point.

The following may be titled retraining of the hypercoder network.

The decoder (e.g., the latents-to-picture decoder 26) is not the only part of the VAE affected by approximating quantization functions. The hypercoder network may be optimized according to embodiments of this invention to provide probability distribution estimates for the perturbed quantization indices 2, which may be distributed differently to the truly quantized latents. Therefore, a third experiment according to embodiments of this invention was set up, which retrained the entire hypercoder system as described in (2) and (3) together with the decoder (e.g., the latents-to-picture decoder 26) as in the previous experiment. To allow for the hyperencoder (e.g., the hyperencoder 46) to be trained as well, the quantization of the hyperprior y was again replaced with the approximation (9), and only the latent is truly quantized with USQ. To include the hypercoder in the training process, the loss term for this retraining includes both the distortion and the rate, following (10). This configuration according to an embodiment may allow \hat{μ} and \hat{σ} to adjust to the real quantization indices instead of their continuous approximations through the rate term. Out of all weights w, the weight parameters

$${w}_{hypenc} , {w}_{hpmf} , {w}_{hypdec}^{mean} , {w}_{hypdec}^{dev} ,$$

and w_{dec} were optimized. It must be noted that \hat{μ} is unable to gather useful gradients for the optimization process in relation to the distortion. Therefore, the gradient calculation for \hat{μ} may intentionally be zeroed out in the quantization functions (7), allowing the mean to only be optimized with respect to the rate. The BD-rate results of this experiment are listed in the table 500. Retraining both the hypercoder on rate and the decoder (e.g., the latents-to-picture decoder 26) on distortion leads to a generally favorable BD-rate in comparison to the anchor model of −1.14% for high bitrates, and −1.73% for low bitrates. This also may constitute an improvement over the pure decoder (e.g., the latents-to-picture decoder 26) retrain according to embodiments of this invention, against which a BD-rate of −0.27% and −0.49% was measured. This improvement over the first experiment may be mostly due to ability of this configuration to jointly optimize rate and distortion. Depending on the circumstances one or the other embodiment of the invention may be chosen. Similar to the distortion measure, the bitrate consistently decreased for every data point in almost every experiment (except for tested Kodak images 20, 21, and 22, which experienced slightly higher bitrates at high rate working points). The average decrease in bitrate is 0.0015 bits per sample.

The following may be titled outlook.

As the TCQ process uses the estimated normal distribution provided by the hypercoder to generate the quantized latents (e.g., quantized latents 24), optimizing the TCQ hypernetwork and decoder (e.g., latents-to-picture decoder 12) together would entail computing 2 on-the-fly. As the retrained hypercoder may change the trellis costs in the Viterbi algorithm at inference, it may also lead to a different quantization pattern not reflected by the static, offline generated latent dataset. Thus, the current approach may lead to mismatching distributions between the dequantized latents of the training data and inference data. This dissonance may be remedied in future experiments. However, the general approach of reoptimizing the decoder (e.g., decoder 10) according to an embodiment of this invention with respect to distortion on truly quantized data produces favorable results, leading to general PSNR increases as listed in the table 600. Note the larger improvement of the TCQ model retraining in comparison to the USQ decoder retrain, both according to embodiments of this invention. This PSNR improvement indicates that a proper approximation of complicated quantization functions may generally be harder to achieve than for simple schemes like USQ. The retraining step according to embodiments is easily applicable to other architectures and quantization schemes.

The following may be titled Conclusion.

We show that incorporating a retraining (e.g., training 35, training 47 or training 38) according to an embodiment of the decoder network (e.g., the decoder 10) into a training process increases reconstruction quality. Especially if the quantization function is more complex, or harder to approximate with a gradient-friendly function, optimizing the decoder (the decoder 10) on truly quantized latents (e.g., quantized latents 24i) according to an embodiment leads to better coding efficiency due to the more accurate nature of the training data in comparison to the conventional approximation with uniformly distributed quantization noise. This is tested for the simple USQ function, leading to a PSNR increase of more than 0.1 dB, as well for a TCQ implementation with increases up to 0.19 dB. Designing the retraining step according to an embodiment to allow training through the rate term of the objective similarly showed improvements for both bitrate and reconstruction quality.

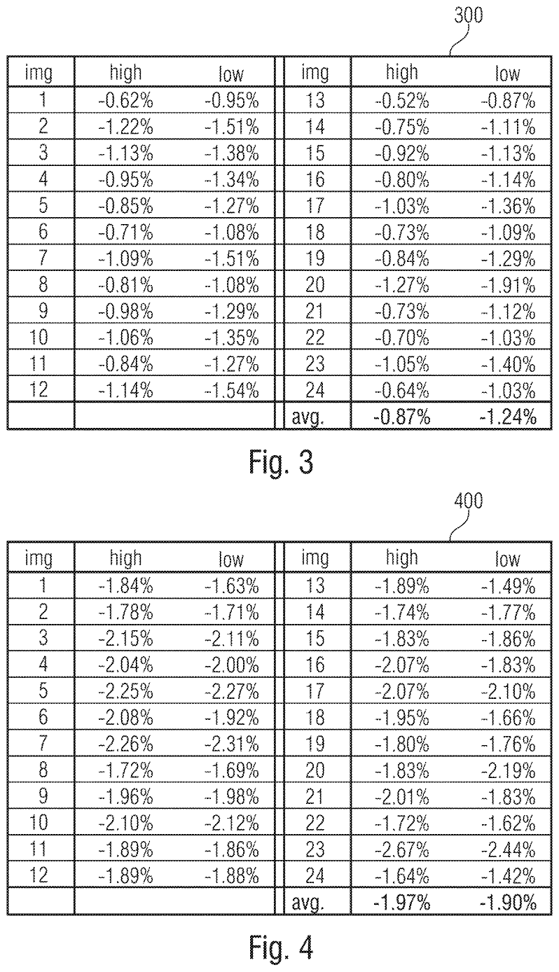

In the following, FIG. 3 will be described. FIG. 3 is showing a table 300 of BD-Rates of KODAK images encoded with the retrained USQ decoder model according to embodiments compared to the a USQ anchor model.

The results shown in this figure originate from an experiment, wherein the latent-to-picture decoder 26 was trained 38 on a training set 30, that was optimized for USQ quantization. For this, the decoder 10 trained for USQ were retrained 38 according to embodiments of this invention by replacing the quantization approximation function (8) with the true quantization function (7), including the mean shift. The training 38 according to embodiments of this invention was then conducted with only the weights of the latent-to-picture decoder 26 being allowed to be adjusted, with the encoder 12 and the entire hypercoder being effectively frozen. This excludes the rate term from the training process and simplifies the training objective to (13).

The BD-rates achieved by this retraining 38 are listed in the table 300. The BD-rate is a measure that compares a PSNR-rate curve (given by a set of data points) against a reference PSNR-rate curve and specifies the average relative rate difference to the reference curve for the same PSNR, where negative values indicated bitrate savings [20]. Retraining the decoder 10 according to embodiments of this invention leads to a BD-rate of −0.87% for high bitrates and −1.24% for low bitrates, meaning that the retraining improved the model's performance.

In the following FIG. 4 will be described. FIG. 4 is showing a table 400 of BD-Rates of KODAK images encoded with the retrained TCQ decoder 10 model according to embodiments compared to the a TCQ anchor model. In order to test whether a latent-to-picture decoder 26 retraining 38 according to embodiments of this invention is also advantageous for more advanced quantization schemes, an experiment was conducted, wherein the latent-to-picture decoder 26 was trained 38 on a training set 30, that was optimized for TCQ quantization. Replacing the approximation function with a true TCQ process is nontrivial, so TCQ was applied offline to the entire dataset, pregenerating a comprehensive training set 30 of TCQ quantized latents (e.g., \hat{z}). This pregenerated training set 30 was then loaded in for the training 38 process, allowing the decoder 10 to train on real TCQ data. The experimental results of the retrained decoder 10 for TCQ according to embodiments of this invention in comparison to the original anchor models are listed in the table 400. Similar to the previous experiment, the improvement is consistent over all rate points and test images, with an average BD-rate of −1.97% for high bitrates, and −1.90% for low bitrates. As with USQ, retraining the TCQ decoder 10 only leads to reconstruction improvements. The results of the experiment with USQ optimized models can be seen in table 300. The average PSNR increase of all rate points across the inference dataset is 0.136 dB, with no model decreasing in quality at any point.

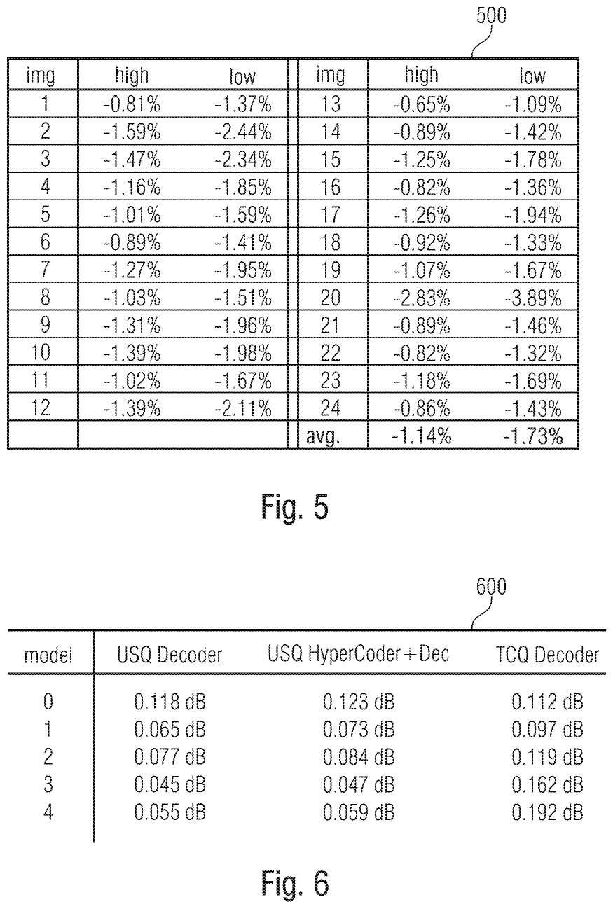

In the following FIG. 5 will be described. FIG. 5 is showing a table 500 of BD-Rates of KODAK images encoded with the USQ model with a retrained hypercoder network and latent-to-picture decoder according to embodiments, compared to a USQ anchor model. The latents-to-picture decoder 26 is not the only part of the VAE affected by approximating quantization functions. The hypercoder network may be additionally optimized according to embodiments of this invention to provide probability distribution estimates for the perturbed quantization indices 2, which may be distributed differently to the truly quantized latents. Therefore, this experiment according to embodiments of this invention was set up, which retrained the entire hypercoder system together with the latents-to-picture decoder 26 as in the previous experiment. To allow for the hyperencoder hyperencoder 46 to be trained as well, the quantization of the representation in the hyper quantizer 54 was again replaced with the approximation (9), and only the latents (e.g., the unquantized latents 44) are truly quantized with USQ. To include the hypercoder in the training process, the loss term for this retraining includes both the distortion and the rate, following (10). This configuration according to embodiments may allow the hypercoder to adjust to the real quantization indices instead of their continuous approximations through the rate term. Out of all weights w, the weight parameters w_{hypenc}, w_{hpmf}

$${w}_{hypdec}^{mean} , {w}_{hypdec}^{dev} ,$$

and w_{dec} were optimized, corresponding to the hyperencoder 46, the hyper quantizer 54, the hyperdecoder 14 and the latent-to-picture decoder 12.

The BD-rate results of this experiment are listed in the table 500. Retraining both the hypercoder on rate and the decoder (e.g., the latents-to-picture decoder 26) on distortion leads to a generally favorable BD-rate in comparison to the anchor model of −1.14% for high bitrates, and −1.73% for low bitrates. This also may constitute an improvement over the pure latent-to-picture decoder 26 retrain 38 according to embodiments of this invention, against which a BD-rate of −0.27% and −0.49% was measured. This improvement over the experiment of FIG. 3 may be mostly due to ability of this configuration to jointly optimize rate and distortion. Depending on the circumstances one or the other embodiment of the invention may be chosen. Similar to the distortion measure, the bitrate consistently decreased for every data point in almost every experiment (except for tested Kodak images 20, 21, and 22, which experienced slightly higher bitrates at high rate working points). The average decrease in bitrate is 0.0015 bits per sample.

In the following FIG. 6 will be described. FIG. 6 is showing a table 600 of absolute average PSNR differences between the USQ/TCP experiments and their anchor models. The general approach of embodiments of this invention of reoptimizing the decoder 10 with respect to distortion on truly quantized data appears to produce favorable results, leading to general PSNR increases as listed in the table 600.

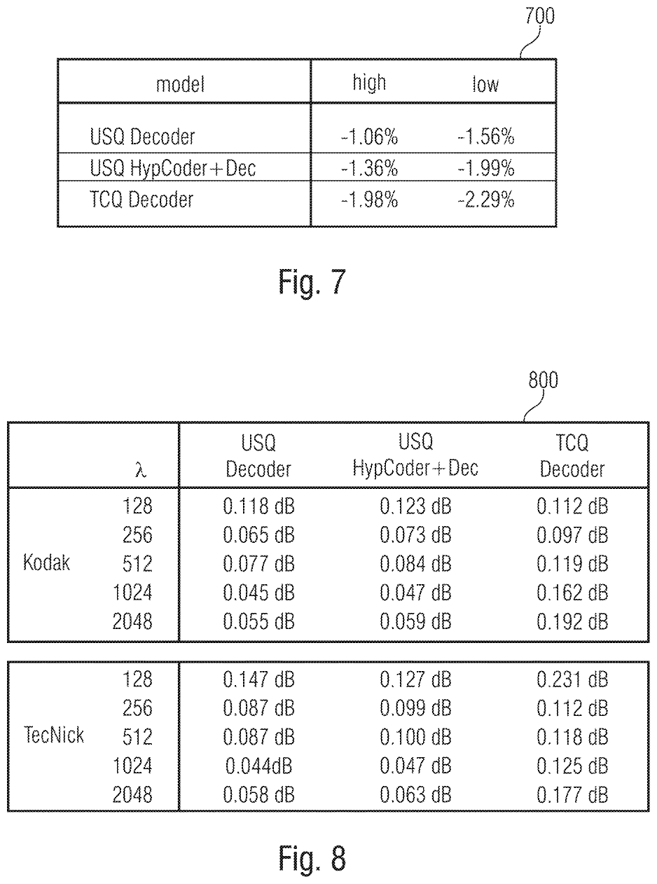

In the following FIG. 7 will be described. FIG. 7 is showing a table 700 of average BD-rates between retrained models and their respective anchors for the TecNick test dataset. The models listed correspond to Variational auto encoder coding models as disclosed above. The model USQ Decoder corresponds to a model, which uses USQ quantization and in which the latents-to-picture decoder 26 was further trained 38 according to an embodiment. The USQ HyperCoder+Dec model corresponds to a model, which uses USQ quantization and in which the Hypercoder system as well as the latents-to-picture decoder 26 was further trained 35. The TCQ Decoder model corresponds to a model, which uses TCP quantization and in which the latents-to-picture decoder 26 was further trained 38.

In the following FIG. 8 will be described. FIG. 8 is showing a table 800 of absolute average PSNR differences between the USQ/TCQ experiments and their respective anchor models. In FIG. 8 λ denotes the Lagrange parameter. Furthermore, the models listed correspond to Variational auto encoder coding models as disclosed above. The model USQ Decoder corresponds to a model, which uses USQ quantization and in which the latents-to-picture decoder 26 was further trained 38 according to an embodiment. The USQ HyperCoder+Dec model corresponds to a model, which uses USQ quantization and in which the Hypercoder system as well as the latents-to-picture decoder 26 was further trained 35. The TCQ Decoder model corresponds to a model, which uses TCP quantization and in which the latents-to-picture decoder 26 was further trained 38.

It should be noted that any embodiments as defined by the claims can be supplemented by any of the details (features and functionalities) described in the text above.

Also, the embodiments described in the text above can be used individually, and can also be supplemented by any of the features in another chapter, or by any feature included in the claims.

Also, it should be noted that individual aspects described herein can be used individually or in combination. Thus, details can be added to each of said individual aspects without adding details to another one of said aspects.

Moreover, features and functionalities disclosed herein relating to a method can also be used in an apparatus (configured to perform such functionality). Furthermore, any features and functionalities disclosed herein with respect to an apparatus can also be used in a corresponding method. In other words, the methods disclosed herein can be supplemented by any of the features and functionalities described with respect to the apparatuses.

Also, any of the features and functionalities described herein can be implemented in hardware or in software, or using a combination of hardware and software, as will be described in the section “implementation alternatives”.

The following may be titled Implementation alternatives.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a microprocessor, a programmable computer or an electronic circuit. In some embodiments, one or more of the most important method steps may be executed by such an apparatus.

Depending on certain implementation requirements, embodiments of the invention can be implemented in hardware or in software. The implementation can be performed using a digital storage medium, for example a floppy disk, a DVD, a Blu-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. The data carrier, the digital storage medium or the recorded medium are typically tangible and/or non-transitionary.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods may be performed by any hardware apparatus.

The apparatus described herein may be implemented using a hardware apparatus, or using a computer, or using a combination of a hardware apparatus and a computer.

The apparatus described herein, or any components of the apparatus described herein, may be implemented at least partially in hardware and/or in software.

The methods described herein may be performed using a hardware apparatus, or using a computer, or using a combination of a hardware apparatus and a computer.

The methods described herein, or any components of the apparatus described herein, may be performed at least partially by hardware and/or by software.

The above described embodiments are merely illustrative for the principles of the present invention. It is understood that modifications and variations of the arrangements and the details described herein will be apparent to others skilled in the art. It is the intent, therefore, to be limited only by the scope of the impending patent claims and not by the specific details presented by way of description and explanation of the embodiments herein.

### REFERENCES

[1]J. Ascenso, E. Alshina, and T. Ebrahimi, “The JPEG AI Standard: Providing Efficient Human and Machine Visual Data Consumption,” IEEE MultiMedia, vol. 30, no. 1, pp. 100-111, 2023.
[2]M. Lu, P. Guo, H. Shi, C. Cao, and Z. Ma, “Transformer-based Image Compression,” 2021.
[3]B. Bross, Y.-K. Wang, Y. Ye, S. Liu, J. Chen, G. J. Sullivan, and J.-R. Ohm, “Overview of the Versatile Video Coding (VVC) Standard and its Applications,” IEEE Transactions on Circuits and Systems for Video Technology, vol. 31, no. 10, pp. 3736-3764, 2021.
[4]G. J. Sullivan, J.-R. Ohm, W.-J. Han, and T. Wiegand, “Overview of the high efficiency video coding (HEVC) standard,” IEEE Transactions on circuits and systems for video technology, vol. 22, no. 12, pp. 1649-1668, 2012.
[5]J. Ball'e, P. A. Chou, D. Minnen, S. Singh, N. Johnston, E. Agustsson, S. J. Hwang, and G. Toderici, “Nonlinear Transform Coding,” IEEE Journal of Selected Topics in Signal Processing, vol. 15, no. 2, pp. 339-353, 2021.
[6]G. G. Langdon, “An Introduction to Arithmetic Coding,” IBM Journal of Research and Development, vol. 28, no. 2, pp. 135-149, 1984.
[7]J. Ball'e, D. Minnen, S. Singh, S. J. Hwang, and N. Johnston, “Variational image compression with a scale hyperprior,” 2018.
[8]D. Minnen, J. Ball'e, and G. D. Toderici, “Joint Autoregressive and Hierarchical Priors for Learned Image Compression,” in Advances in Neural Information Processing Systems, S. Bengio, H. Wallach, H. Larochelle, K. Grauman, N. Cesa-Bianchi, and R. Garnett, Eds., vol. 31. Curran Associates, Inc., 2018.
[9]D. Minnen and S. Singh, “Channel-Wise Autoregressive Entropy Models for Learned Image Compression,” in 2020 IEEE International Conference on Image Processing (ICIP), 2020, pp. 3339-3343.
[10]Z. Cheng, H. Sun, M. Takeuchi, and J. Katto, “Learned Image Compression With Discretized Gaussian Mixture Likelihoods and Attention Modules,” in Proceedings of the IEEE/CVF Conference on Computer Vision and Pattern Recognition (CVPR), June 2020.
[11]M. Schäfer, S. Pientka, J. Pfaff, H. Schwarz, D. Marpe, and T. Wiegand, “Rate-Distortion Optimized Encoding for Deep Image Compression,” IEEE Open Journal of Circuits and Systems, vol. 2, pp. 633-647, 2021.
[12]K. S\ddot{ } uhring, M. Sch\ddot{ } afer, J. Pfaff, H. Schwarz, D. Marpe, and T. Wiegand, “Trellis-Coded Quantization for End-to-End Learned Image Compression,” in 2022 IEEE International Conference on Image Processing (ICIP), 2022, pp. 3306-3310.
[13]B. Li, M. Akbari, J. Liang, and Y. Wang, “Deep Learning-Based Image Compression with Trellis Coded Quantization,” in 2020 Data Compression Conference (DCC), 2020, pp. 13-22.
[14]J. Ball'e, V. Laparra, and E. P. Simoncelli, “End-to-end optimization of nonlinear transform codes for perceptual quality,” in 2016 Picture Coding Symposium (PCS), 2016, pp. 1-5.
[15]L. Theis, W. Shi, A. Cunningham, and F. Huszár, “Lossy Image Compression with Compressive Autoencoders,” 2017.
[16]Z. Liu, K.-T. Cheng, D. Huang, E. P. Xing, and Z. Shen, “Nonuniformto-Uniform Quantization: Towards Accurate Quantization via Generalized Straight-Through Estimation,” in Proceedings of the IEEE/CVF Conference on Computer Vision and Pattern Recognition (CVPR), June 2022, pp. 4942-4952.
[17]D. Minnen, J. Ball'e, and G. D. Toderici, “Joint Autoregressive and Hierarchical Priors for Learned Image Compression,” in Advances in Neural Information Processing Systems, S. Bengio, H. Wallach, H. Larochelle, K. Grauman, N. Cesa-Bianchi, and R. Garnett, Eds., vol. 31. Curran Associates, Inc., 2018.
[18]S. Pan, C. Finlay, C. Besenbruch, and W. Knottenbelt, “Three Gaps for Quantisation in Learned Image Compression,” in Proceedings of the IEEE/CVF Conference on Computer Vision and Pattern Recognition (CVPR) Workshops, June 2021, pp. 720-726.
[19]K. Tsubota and K. Aizawa, “Comprehensive Comparisons of Uniform Quantization in Deep Image Compression,” IEEE Access, vol. 11, pp. 4455-4465, 2023.
[20]G. Bjontegaard, “Calculation of average PSNR differences between RDcurves,” ITU SG16 Doc. VCEG-M33, 2001.
[21]J. Ball'e, V. Laparra, and E. P. Simoncelli, “Density Modeling of Images using a Generalized Normalization Transformation,” 2016.
[22]Y. Chen, H. Fan, B. Xu, Z. Yan, Y. Kalantidis, M. Rohrbach, S. Yan, and J. Feng, “Drop an Octave: Reducing Spatial Redundancy in Convolutional Neural Networks With Octave Convolution,” in Proceedings of the IEEE/CVF International Conference on Computer Vision (ICCV), October 2019.
[23]T. Lookabaugh and R. Gray, “High-resolution quantization theory and the vector quantizer advantage,” IEEE Transactions on Information Theory, vol. 35, no. 5, pp. 1020-1033, 1989.
[24]H. Schwarz, M. Coban, M. Karczewicz, T.-D. Chuang, F. Bossen, A. Alshin, J. Lainema, C. R. Helmrich, and T. Wiegand, “Quantization and Entropy Coding in the Versatile Video Coding (VVC) Standard,” IEEE Transactions on Circuits and Systems for Video Technology, vol. 31, no. 10, pp. 3891-3906, 2021.
[25]G. Forney, “The viterbi algorithm,” Proceedings of the IEEE, vol. 61, no. 3, pp. 268-278, 1973.
[26]J. Deng, W. Dong, R. Socher, L.-J. Li, K. Li, and L. Fei-Fei, “ImageNet: A large-scale hierarchical image database,” in 2009 IEEE Conference on Computer Vision and Pattern Recognition, 2009, pp. 248-255.
[27] Kodak image dataset. [Online]. Available: http://r0k.us/graphics/kodak/
[28] Tensorflow. [Online]. Available: https://www.tensorflow.org/

1. An apparatus for further training a pre-trained version of a decoder fitting to a variational picture autoencoder, the decoder comprising
a hyperdecoder for deriving statistical entropy-coding parameters from a quantized hyperprior in a data stream,
an entropy decoder for decoding quantized latents from the data stream using the statistical entropy-coding parameters, and
a latents-to-picture decoder for deriving from the quantized latents a decoded picture, the apparatus configured to
provide a training set of training data elements corresponding to a set of various test pictures, each training data element comprising
quantized latents resulting from applying the variational picture autoencoder to an associated test picture, and
train the latents-to-picture decoder on the training set with respect to distortion optimization to acquire a further trained version of the latents-to-picture decoder.

2. The apparatus according to claim 1, configured to
train the latents-to-picture decoder on the training set with respect to distortion optimization by means of a gradient descent method with optimizing a parametrization of the latents-to-picture decoder using a cost function measuring the picture distortion.

3. The apparatus according to claim 1, wherein the entropy decoder is an arithmetic decoder.

4. The apparatus according to claim 1, wherein the statistical entropy-coding parameters comprise a central tendency measure and dispersion measure for each of the quantized latents.

5. The apparatus according to claim 1, configured to
provide the training set by, for each training data element, applying a picture-to-latents encoder and a latent quantizer of the variational picture autoencoder onto a corresponding test picture of the set of various test pictures, the variational picture autoencoder comprising
the picture-to-latents encoder for deriving from a picture to be encoded unquantized latents,
the latent quantizer for quantizing the unquantized latents to acquire the quantized latents,
a hyperencoder for deriving a representation of the statistical entropy-coding parameters from the unquantized latents,
a hyper quantizer for quantizing the representation of the statistical entropy-coding parameters to acquire the quantized hyperprior from which the statistical entropy-coding parameters are derivable by the hyperdecoder,
an entropy encoder for encoding the quantized latents into the data stream using the statistical entropy-coding parameters,
wherein the variational picture autoencoder is configured to write the quantized hyperprior into the data stream.

6. The apparatus according to claim 1, each training data element further comprising
an encoding rate of the quantized latents.

7. The apparatus according to claim 1, configured to
provide a further training set of further training data elements corresponding to a further set of various test pictures, each further training data element comprising
unquantized latents and quantized latents resulting from applying the variational picture autoencoder to an associated test picture, and
train a hypercoder system comprising the hyperdecoder and a hyperencoder of the variational picture autoencoder on the further training set with fixedly using the further trained version of the latents-to-picture decoder with respect to rate-distortion optimization to acquire a further trained version of the hyperdecoder and a further trained version of the hyperencoder.

8. The apparatus according to claim 7, wherein the set of various test pictures equals the further set of various test pictures.

9. The apparatus according to claim 1, wherein
the training set is provided so that each training data element comprises
unquantized latents related to the quantized latents, and
the training trains the latents-to-picture decoder along with a hypercoder system comprising the hyperdecoder and a hyperencoder of the variational picture autoencoder to acquire, in addition to the further trained version of the latents-to-picture decoder, a further trained version of the hyperdecoder and a further trained version of the hyperencoder.

10. An apparatus for further training a pre-trained version of a decoder fitting to a variational picture autoencoder, the decoder comprising
a hyperdecoder for deriving statistical entropy-coding parameters from a quantized hyperprior in a data stream,
an entropy decoder for decoding quantized latents from the data stream using the statistical entropy-coding parameters, and
a latents-to-picture decoder for deriving from the quantized latents a decoded picture, the apparatus configured to
provide a further training set of further training data elements corresponding to a further set of various test pictures, each further training data element comprising
unquantized latents and quantized latents resulting from applying the variational picture autoencoder to an associated test picture, and
train a hypercoder system comprising the hyperdecoder and a hyperencoder of the variational picture autoencoder on the further training set with respect to rate-distortion optimization to acquire a further trained version of the hyperdecoder and a further trained version of the hyperencoder.

11. The apparatus according to claim 10, configured to
train, with respect to rate-distortion optimization, the hypercoder system on the further training set with fixedly using the pre-trained version of the decoder as far as the latents-to-picture decoder is concerned, by means of a gradient descent method with optimizing a parametrization of the hypercoder system using a cost function defined by a Lagrangian cost function of a picture distortion measure and a coding rate measure.

12. The apparatus according to claim 10, configured to
provide the further training set by, for each training data element of the training set, applying a picture-to-latents encoder and a latent quantizer of the variational picture autoencoder onto a corresponding test picture of the further set of various test pictures, the variational picture autoencoder comprising
the picture-to-latents encoder for deriving from a picture to be encoded unquantized latents,
the latent quantizer for quantizing the unquantized latents to acquire the quantized latents,
a hyperencoder for deriving a representation of the statistical entropy-coding parameters from the unquantized latents,
a hyper quantizer for quantizing the representation of the statistical entropy-coding parameters to acquire the quantized hyperprior from which the statistical entropy-coding parameters are derivable by the hyperdecoder,
an entropy encoder for encoding the quantized latents into the data stream using the statistical entropy-coding parameters,
wherein the variational picture autoencoder is configured to write the quantized hyperprior into the data stream.

13. The apparatus according to claim 10, configured to output the further trained version of the hyperdecoder and the further trained version of the hyperencoder at an output of the apparatus for an update of the variational picture autoencoder.

14. The apparatus according to claim 10,
wherein the hypercoder system further comprises a hyperquantizer; and
wherein the training of the hypercoder further is configured such that a further trained version of the hyperquantizer is acquired.

15. A decoder fitting to a variational picture autoencoder, the decoder comprising
a hyperdecoder for deriving statistical entropy-coding parameters from a quantized hyperprior in a data stream,
an entropy decoder for decoding quantized latents from the data stream using the statistical entropy-coding parameters, and
a latents-to-picture decoder for deriving from the quantized latents a decoded picture,
wherein a parametrization of the latents-to-picture decoder lies in a minimum of a distortion function from a quantized latent domain to distortion with respect to parameters of the latents-to-picture decoder.

16. A system of a variational picture autoencoder and a decoder fitting to the variational picture autoencoder, wherein
the decoder comprises
a hyperdecoder for deriving statistical entropy-coding parameters from a quantized hyperprior in a data stream,
an entropy decoder for decoding quantized latents from the data stream using the statistical entropy-coding parameters, and
a latents-to-picture decoder for deriving from the quantized latents a decoded picture, and
the variational picture autoencoder comprises
the picture-to-latents encoder for deriving from a picture to be encoded unquantized latents,
the latent quantizer for quantizing the unquantized latents to acquire the quantized latents,
a hyperencoder for deriving a representation of the statistical entropy-coding parameters from the unquantized latents,
a hyper quantizer for quantizing the representation of the statistical entropy-coding parameters to acquire the quantized hyperprior from which the statistical entropy-coding parameters are derivable by the hyperdecoder,
an entropy encoder for encoding the quantized latents into the data stream using the statistical entropy-coding parameters,
wherein a parametrization of the latents-to-picture decoder lies in a minimum of a distortion function from a quantized latent domain to distortion with respect to parameters of the latents-to-picture decoder
and/or
wherein a parametrization of a hypercoder system comprising the hyperdecoder and the hyperencoder lies in a minimum of a rate-distortion Lagrangian function from an unquantized-latents-and-quantized-latents domain to a Lagrangian sum of rate and distortion with respect to parameters of the hyperdecoder and the hyperencoder and fixedly with respect to the parametrization of the latents-to-picture decoder.
